(19) United States
(12) Patent Application Publication
(10) Pub. No.: US 2005/0088844 A1
(43) Pub. Date: Apr. 28, 2005

(54) Modular fluorescent light fixture

(76) Inventors: John J. Wordin, Kualapuu, HI (US); Roland Ejercito, Honolulu, HI (US)

Correspondence Address: John J. Wordin, P.O. Box 121, Kualapuu, HI, 96757-0121, US

(21) Appl. No.: 10/693,404

(22) Filed: Oct. 24, 2003

(51) Int. Cl. F21S 4/00

(52) U.S. Cl. 362/217; 362/260; 362/219; 362/222; 362/346; 362/347; 362/361

(57) ABSTRACT

Disclosed is a modular fluorescent light fixture combing a hyperbolically shaped reflector with T5 fluorescent tubes. The resulting fluorescent light fixture provides adequate light levels while saving energy. Two modular fluorescent light fixtures can be combined in two ways, with tubes either parallel or perpendicular to each other, to form a troffer having unique capabilities.

### CROSS-REFERENCE TO RELATED APPLICATIONS

Wordin, J. J,: U.S. Pat. No. 6,170,962; “Dual Compound Reflector for Fluorescent Light Fixtures” issued Jan. 9, 2001.

### STATEMENT REGARDING FEDERALLY SPONSORED RESEARCH OR DEVELOPMENT

n/a

### BACKGROUND OF THE INVENTION

1. Field of the Invention

This invention relates to a fluorescent light fixture using a reflector and T5 fluorescent tubes to enhance illumination of a surface located below the fluorescent light fixture. The purpose of the light fixture is to save energy while supplying adequate levels of illuminations.

2. Background Information

The F28T5 fluorescent tubes are ⅝-inch in diameter and 1143 mm (45 inches) long, consume 28 watts of energy, and supply 2900 initial lumens. The efficacy, defined as the lumens per watt, is 103 for this T5 tube. This is higher than for the T8 or the T12 fluorescent tubes. Because of the high efficacy of the T5 tubes, it is desirable to create a new light fixture using these tubes. The T8 and T12 tubes are 1194 mm (47 inches) in length while the T5 is 1143 nn (45 inches) in length. This makes the T5 tubes incompatible with existing light fixtures. In addition, the sockets required for the T5 tubes are smaller thus making the T8 and T12 sockets too large to accommodate the T5 tubes. A problem is the fact that T5 tubes are long and thin and not structurally sound, and as a result, they experience higher than normal breakage during shipping. Insurance rates are high for such shipments.

The F14T5 fluorescent tube is ⅝-inch in diameter, 558 mm (22 inches) long, with initial lumens of 1350 lumens. It has an efficacy of 96, which is not as good as the longer tube, but still superior to the T8 or T12 tubes. Because of their shorter length of 558 mm (22 inches), these T5 tubes do not experience the brakeage in shipping that the longer T5 tubes exhibit.

For all the above reasons, it is desirable to create a new fluorescent light fixture, which utilizes the T5 fluorescent tube of 558 mm (22 inches) in length.

### BRIEF SUMMARY OF THE INVENTION

This invention involves an article of manufacture, namely a fluorescent light fixture. A patented reflector, hyperbolic in shape, is combined with the shorter T5 fluorescent tubes to create this new, useful, and unique innovation. The resulting modular fluorescent light fixture is square in plan form. Two modular fluorescent light fixtures can be installed side by side in the ceiling overhead to form a complete troffer. The two modular fluorescent light fixtures can be combined in two orientations, each combination giving unique lighting performance.

### BRIEF DESCRIPTION OF THE DRAWINGS

In FIG. 1 is shown the embodiment of the modular fluorescent light fixture, shown in cross-section.

FIG. 2 shows the bottom view of the light fixture with T5 tubes and hyperbolically shaped reflector.

FIG. 3 shows how two modular fluorescent light fixtures can be installed so the tubes are parallel to each other.

FIG. 4 shows how two modular fluorescent light fixtures can be installed so the tubes are perpendicular to each other.

FIG. 5 shows a cross-section of the end of the fixture to illustrate one way the parts can be assembled into a complete fluorescent light fixture.

### DETAILED DESCRIPTION OF THE INVENTION

The paragraph below describes the preferred embodiment of this new and unique modular fluorescent energy-saving light fixture and its new uses.

### DESCRIPTION OF THE PREFERRED EMBODIMENT

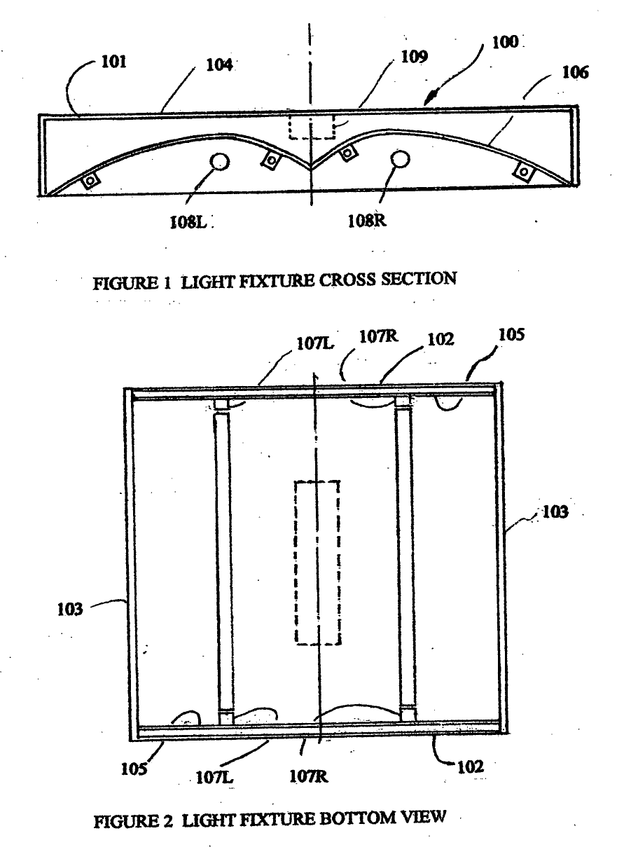

A cross-sectional diagram of the preferred embodiment of the modular light fixture is show in FIG. 1. FIG. 2 shows the bottom view of the modular fluorescent fixture, which is generally square in shape. A modular fluorescent light fixture consists of a housing, which is a 5-sided box in configuration, a reflector, and electrical components. The 5-sided housing consists of housing ends, housing sides, and a housing top. Attached to the inside of the housing ends of the housing are socket supports. The socket supports are spaced to accommodate the length of the F14T5 fluorescent light tube. The reflector can be any shape defined by a conic section such as an ellipse, parabola, or hyperbola. The preferred shape for the reflector, however, is the dual compound reflector described in U.S. Pat. No. 6,170,962, which is hyperbolic in cross-section. The reflector is held in place by attaching the reflector to the socket supports and housing sides. Two T5 socket sets, used to hold the two T5 fluorescent tubes in place and to supply electrical power to the fluorescent tubes, are mounted to the socket supports. The housing also contains a ballast of the common type according to the known art to supply electrical power to the fluorescent tubes by an electrical circuit connecting the ballast to the socket sets.

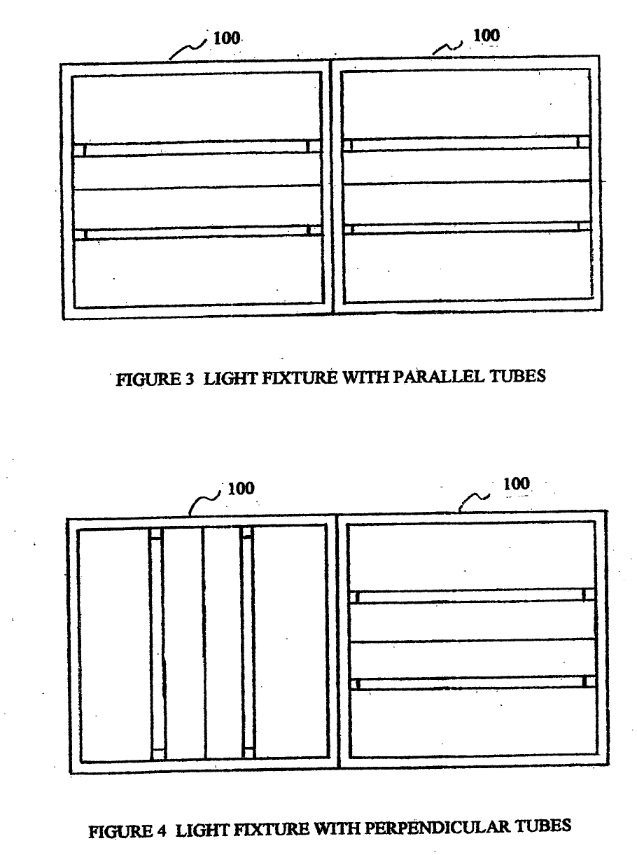

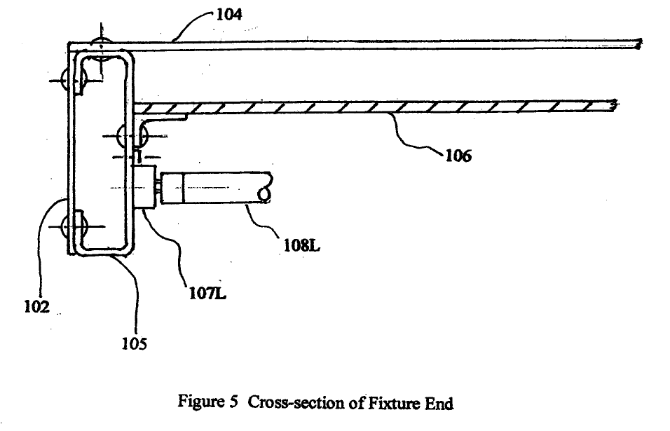

Fluorescent light fixtures found in offices and similar places are generally twice as long as they are wide. Two modular fluorescent light fixtures can be installed together to make a typical fixture called a troffer. The modular fluorescent light fixtures can be configured in two ways: first, with the tubes in both modules being parallel to each other, as shown in FIG. 3, or, second, with the tubes of the modules perpendicular to each other, as shown in FIG. 4. This second fixture configuration is useful in the corners of a room and represents a new use.

### SPECIFIC DESCRIPTION OF THE INVENTION

Modula light fixture 100, comprising a housing 101, is made up of housing ends, 102, housing sides, 103, and a housing top, 104. At each end of the housing, 101, attached to the inside of the housing ends, 102, are located socket supports, 105. The inside spacing of the socket supports, 105, is such as to accommodate the length of the F14T5 fluorescent tube. A dual compound reflector, 106, is attached to the socket supports, 105, and the housing sides, 103. Two T5 sockets sets, 107R and 107L, are mounted on the socket supports, 105, the right T5 fluorescent tube, 108R plugs into the right socket set, 107R, and the left T5 fluorescent tube, 108L, plugs into the left T5 socket set, 107L. The left and right socket sets, 107R and 107L, are electrically connected in a conventional way according to the known art to a ballast, 110. The ballast is mechanically attached to the housing, 101.

Two modular light fixtures, 100, can be installed adjacent to each other in two ways. The first way is for the two fixtures, 100, installed with the fluorescent tubes, 108R and 108L, being parallel, as shown in FIG. 3, The second method is for the two modular light fixtures, 100, installed with the fluorescent tubes 108R and 108L, being perpendicular to each other, as shown in FIG. 4.

The foregoing description of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its principle application to thereby enable one of ordinary skill in the art to best utilize the invention in various embodiments and with various modifications as are suited to the particular use contemplated. It is intended that the scope of the invention be defied by the claims, which are appended.

1. A modular fluorescent light fixture comprising a 5-sided housing consisting of housing ends, housing sides, and a housing top, with socket supports attached at each end of said housing inside and mounted to said housing ends, said socket support having T5 socket sets attaching thereto, having a reflector mounted to said socket supports and said housing sides, having two F14T5 fluorescent tubes inserted into said socket sets in front of said reflector, having a ballast mechanically attaching to said housing having electrical connections from said ballast to said socket sets.

2. The modular fluorescent flight fixture of claim 1, consisting of said modular fluorescent light fixture installed adjacent to an identical second modular fluorescent light fixture of claim 1, having the fluorescent tubes of the respective modular fixtures oriented parallel to each other.

3. The modular fluorescent flight fixture of claim 1, consisting of said modular fluorescent light fixture installed adjacent to an identical second modular fluorescent light fixture of claim 1, having the fluorescent tubes of the respective modular fixtures oriented perpendicular to each other.

4. The modular fluorescent light fixture of claim 1, where said reflector is in the shape of a dual compound hyperbolic reflector.
